(19) United States
(12) Patent Application Publication
(10) Pub. No.: US 2014/0150758 A1
(43) Pub. Date: Jun. 5, 2014

(54) EXHAUST GAS RECIRCULATION SYSTEM WITH CONDENSATE REMOVAL

(71) Applicant: GENERAL ELECTRIC COMPANY, Schenectady, NY (US)

(72) Inventors: James Richard Zurlo, Madison, WI (US); Brian Murphy, Pewaukee, WI (US); Kevin Paul Konkle, West Bend, WI (US)

(73) Assignee: GENERAL ELECTRIC COMPANY, Schenectady, NY (US)

(21) Appl. No.: 13/693,558

(22) Filed: Dec. 4, 2012

(51) Int. Cl. F02M 25/07

(52) U.S. Cl. CPC F02M 25/0701
USPC 123/568.12

(57) ABSTRACT

A system for recirculating exhaust gas includes a cooling subsystem configured to cool the exhaust gas; a condensation removal subsystem; and a temperature adjustment subsystem. The cooling subsystem may include a first cooling component configured to cool the exhaust gas to a first intermediate temperature and a second cooling component configured to cool the exhaust gas to a temperature below the saturation temperature. The condensation removal subsystem may include a mist eliminator configured to remove condensate and particulate matter from the exhaust gas and a reheater where exhaust gas is reheated to above the saturation temperature.

### GOVERNMENT RIGHTS

This invention was made with Government support under contract number DE-FC26-01CH11080 awarded by the Department Of Energy. The Government has certain rights in this invention.

### TECHNICAL FIELD

The subject matter disclosed herein generally relates to exhaust gas recirculation systems, and more specifically to exhaust gas recirculation systems configured to control vapor content of exhaust gas used in EGR systems and to remove condensates, vapors, gases, ash, and particulates.

### BACKGROUND

Internal combustion engines combust fuel with an oxidizer in a combustion chamber. The expanding gas produced by combustion applies direct force to pistons, turbine blades, or nozzles, transforming chemical energy into useful mechanical energy. Internal combustion engines are often required to meet strict standards for emissions including emissions of nitrogen oxides (NOx), hydrocarbon (HC), formaldehyde (HCHO), carbon monoxide (CO), ammonia (NH3), particulates and other emissions.

NOx emissions may be reduced by using exhaust gas recirculation (“EGR”) to dilute the charge air and depress the maximum temperature reached during combustion. Typically the exhaust is cooled to avoid increased intake temperatures that may adversely affect engine operation. In some cases, engine coolant is used as a low temperature fluid to cool exhaust gas temperatures in EGR systems.

A problem that arises with the cooling of exhaust gas used in EGR systems is the precipitation of water droplets out of the EGR exhaust gas during the cooling. The water droplets may contribute to bore washing of oil from the engine cylinder bore, thereby reducing lubrication. Water droplets may also have an adverse impact on turbocharger compressor blades. The water also promotes corrosion in the EGR system and the engine intake system. Another problem is the lack of control over the percentage of water vapor in the exhaust gas can make it difficult to control the amount of diluent required to operate consistently in the combustion window between misfire and knock. Still another problem is that ash and particulates present in the EGR exhaust gas may contribute to wear in the engine.

### BRIEF DESCRIPTION OF THE INVENTION

In accordance with one exemplary non-limiting embodiment, the invention relates to a system for recirculating exhaust gas including a cooling subsystem configured to cool the exhaust gas; a condensation removal subsystem; and a temperature adjustment subsystem. In some embodiments the cooling subsystem is configured to cool the exhaust gas to below a saturation temperature. In some embodiments the condensation removal subsystem is configured to remove condensed water droplets from the exhaust and absorb and scrub other exhaust constituents.

In another embodiment, an engine includes a combustion chamber wherein fuel is combusted producing an exhaust gas at a first temperature; an exhaust system coupled with the combustion chamber that collects the exhaust gas. An exhaust gas cooling system may be configured to reduce exhaust gas temperature to below the saturation temperature. A condensate removal system may be coupled with the exhaust gas cooling system configured to precipitate a condensate from the exhaust gas. An intake system may be coupled with the condensate removal system and the combustion chamber.

In another embodiment, a method of recirculating exhaust gas may include cooling the exhaust gas to a temperature below a saturation temperature; removing condensate from the exhaust gas; and heating the exhaust gas to a temperature above the saturation temperature.

Other features and advantages of the present invention will be apparent from the following more detailed description of the preferred embodiment, taken in conjunction with the accompanying drawings which illustrate, by way of example, the principles of certain aspects of the invention.

### BRIEF DESCRIPTION OF THE DRAWINGS

FIG. 1 is a schematic illustration of an arrangement according to an embodiment of the EGR system.

FIG. 2 is a schematic illustration of a low pressure embodiment of the EGR system.

FIG. 3 is a schematic illustration of a high pressure embodiment of the EGR system.

FIG. 4 is a schematic illustration of an alternate high pressure embodiment of the EGR system.

FIG. 5 is a schematic illustration of an alternate high pressure embodiment of the EGR system.

FIG. 6 is a schematic illustration of an alternate high pressure embodiment of the EGR system.

FIG. 7 is a schematic illustration of an embodiment of a cooler that may be utilized in the EGR system.

FIG. 8 is a schematic illustration of an embodiment of a mist eliminator that may be utilized in the EGR system.

FIG. 9 is a high level flowchart illustrating a method that may be implemented by an embodiment of the EGR system.

### DETAILED DESCRIPTION OF THE INVENTION

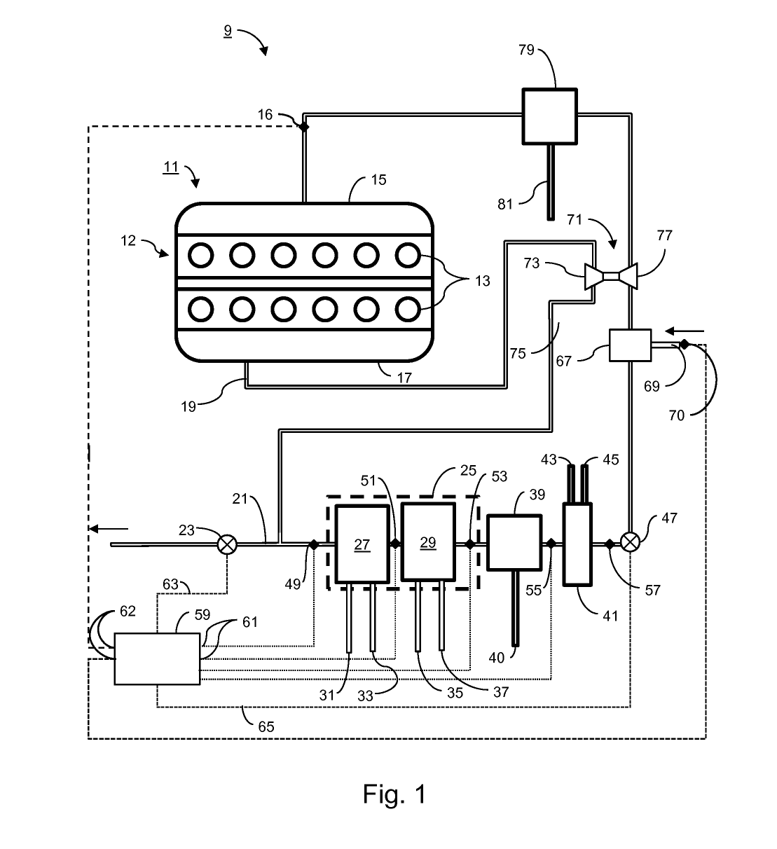

Illustrated in FIG. 1 is an embodiment of an EGR system 9 including an engine 11. Engine 11 may be an internal combustion engine having one or more cylinders 13, an intake manifold 15 and an exhaust manifold 17. An exhaust conduit 19 may be coupled to the exhaust manifold to extract exhaust gas. Exhaust gas may be diverted to an EGR conduit 21 through a variable exhaust gas control valve 23. In some embodiments an orifice may be substituted for variable exhaust gas control valve 23. In some embodiments, a power turbine 82 with or without variable vanes may be substituted for variable exhaust gas control valve 23, as illustrated in FIG. 5 or 6. The exhaust gas may then be passed through a cooler assembly 25 having a first stage cooler 27 and a second stage cooler 29. The first stage cooler 27 and the second stage cooler 29 may be heat exchangers (devices that transfer heat from one medium to another). There are a number of heat exchanger designs that may be used as a cooler, such as for example shell and tube heat exchangers, plate heat exchangers, and plate and shell heat exchangers, among others. The cooling medium of the heat exchanger may include a gas such as air or a liquid such as water, engine coolant or refrigerant. In some embodiments a single cooler or multiple coolers may be used, and each cooler may include single or multiple heat exchangers or a single heat exchanger may include multiple cooler portions.

Associated with the first stage cooler 27 are a first coolant inflow port 31 and a first coolant outflow port 33. In one embodiment the coolant flowing into the first coolant inflow port 31 may be jacket coolant from the engine 11. Associated with the second stage cooler 29 are a second coolant inflow port 35 and a second coolant outflow port 37. In one embodiment, the coolant flowing into the second coolant inflow port 35 may be coolant from an auxiliary coolant tank (not shown) which may be maintained at a temperature in the range of 40° C. to 75° C. or other appropriate temperature. The second stage cooler 29 reduces the temperature of the exhaust gas so that at least a portion of the exhaust gas temperature is reduced to a temperature below the saturation temperature or dew point thereby causing at least a portion of the water in the exhaust to condense into liquid. The temperature of the exhaust gas in the second stage cooler 29 may be used to vary the percentage water that condenses compared to water that remains as vapor. Additionally a valve in the one or more heat exchangers can vary the amount of cooling air or liquid flow rate into the heat exchanger to adjust the temperature of the exhaust gas. The condensate droplets may precipitate and be entrained in the exhaust gas. The cooling medium flow rate, cooling medium temperature and heat exchanger design may be chosen to obtain a preferred water condensation efficiency from the exhaust gas.

The exhaust gas flowing through the second stage cooler 29 may then be passed through a mist eliminator 39 where condensate droplets entrained in the exhaust gas may be precipitated and removed through condensate output port 40. The mist eliminator 39 is a device with a large surface area and small volume to collect liquid without substantially impeding the exhaust gas flow. Alternately, a centrifugal mist eliminator may be used. The mist eliminator 39 collects the fine droplets and allows the collected liquid to drain away through condensate output port 40. The mist eliminator may have multiple stages.

Condensate droplets that remain temporarily attached to the surface of the mist eliminator may improve the efficiency of the mist eliminator 39, and may add functionality to the mist eliminator 39. The temporarily attached droplets may allow the mist eliminator 39 to capture fine condensed droplets from the exhaust gas that would otherwise slip through the mist eliminator 39. The temporarily attached droplets may also cause the mist eliminator 39 to act as a scrubber or an absorber. Solids and liquids that are commonly present in the exhaust gas, such as ash, phosphorus, sulfur, calcium, particulates, carbon, and compounds including such constituents in addition to metals present in the engine that may be in the exhaust due to engine wear may be captured or scrubbed from the exhaust gas by the temporarily attached droplets. Particulates are typically carbonaceous solids that result from the combustion process, that may themselves include dissolved liquids such as oil or volatile organic compounds. In addition, non-condensed water vapor may condense or be absorbed into the temporarily attached droplets. Soluble and non-soluble liquids present in the exhaust gas may also be absorbed or scrubbed from the exhaust gas including ammonia, formaldehyde, benzene, engine oil, and others. Some gaseous components of the exhaust may also be absorbed into the temporarily attached droplets, especially nitrogen oxides, sulfur oxides, and hydrocarbon gases. The mist eliminator 39 may be sized and configured to intentionally maintain temporarily attached droplets on the mist eliminator 39 to optimize scrubbing or absorbing. In particular, the mist eliminator 39 may be configured to optimize removal of ash and particulate compounds in order to prevent such compounds from entering and damaging the cylinders 13. Various mist eliminators operate with different technologies such as using high surface area mesh, alternating vanes, wavy plates, centrifugal forces, sonic energy, electromagnetic energy, or electrostatic forces. Any device or process that removes condensate from the exhaust gas flow may be used.

The exhaust gas flowing through the mist eliminator 39 may then be passed through a reheater 41 where it is reheated to above the saturation temperature. The reheater 41 may be a heat exchanger that includes a reheater fluid inflow port 43 and a reheater fluid outflow port 45. The reheater may alternatively be any device or process that imparts energy to the exhaust gas sufficient to raise the temperature of the exhaust gas, including a heat exchanger that receives its heating energy from engine exhaust, an electric heating element or a microwave generator. The exhaust gas passing through the reheater is then recirculated back into the intake manifold 15 of the engine 11.

EGR flow control valve 47 may be disposed on EGR conduit 21 after the reheater 41 to control the flow rate of the exhaust gas. Control of the EGR flow rate may be used to control the temperature or heat energy of the EGR, or to control the temperature of the combined fresh air and fuel and EGR intake charge after the EGR is introduced into the intake charge, or to control the temperature of the exhaust gas after the EGR is introduced and the charge is combusted, or to control the fraction of EGR that is recycled into the engine relative to the fresh air and fuel in the intake charge or to control the effectiveness of the EGR as an inert on the combustion process.

The EGR system 9 may be provided with one or more of EGR bypass instrumentation 49, stage 1 instrumentation 51, stage 2 instrumentation 53, mist eliminator instrumentation 55, and reheater instrumentation 57 (collectively “instrumentation”). Instrumentation may include temperature sensors, flow rate sensors and pressure sensors.

The EGR system 9 may be provided with a control system 59 that receives instrumentation inputs 61 and provides exhaust gas valve control output 63 and EGR flow control output 65. Additional instrumentation inputs 62 may also be provided from the intake manifold 16 or air intake 70 to the exhaust gas valve output 63 or EGR flow control output 65. Control system 59 may include at least one processor. The control system 59 may be configured to automatically or continuously monitor the operation of the EGR system 9. The control system 59 may function as a stand-alone system or may be integrated as a component of a larger system, such as an internal combustion engine control or a plant control system.

EGR system 9 may include an EGR mixer 67 having an air intake port 69 that combines air from air intake 69 port with exhaust gas. The mixture of exhaust gas and air may be conveyed to a turbocharger 71 having a turbine 73 driven by exhaust provided through exhaust gas input port 75. The turbocharger 71 is optional, and the system may operate using variable exhaust gas control valve 23 and EGR flow control valve 47 without a turbocharger 71. The turbine drives a compressor 77 that compresses the mixture of exhaust gas and air. A secondary mist eliminator 79 having a condensate output port 81 may optionally be provided in high pressure EGR applications.

In operation, the EGR system 9 provides control of the percentage of water vapor provided to the intake manifold 15 of the engine 11 and maintains a more consistent combustion window between misfire and knock. The removal of water droplets from the recirculated exhaust gas reduces or eliminates “bore washing” of oil from the bore by liquid water droplet formed downstream of the compressor or aftercooler. The removal of water droplets from the recirculated exhaust gas prevents droplets from passing into the compressor thereby avoiding damage to the compressor blades resulting from water droplets impinging on the high velocity compressor blades. The reheating of the exhaust gas after it passes through the mist eliminator 39 ensures that the turbocharger compressor blades are not damaged by liquid water droplet impingement. The EGR system 9 improves compressor durability when using low pressure EGR and enables the reliable operation of an EGR engine. Removal of water droplets from the EGR minimizes or eliminates intake system corrosion.

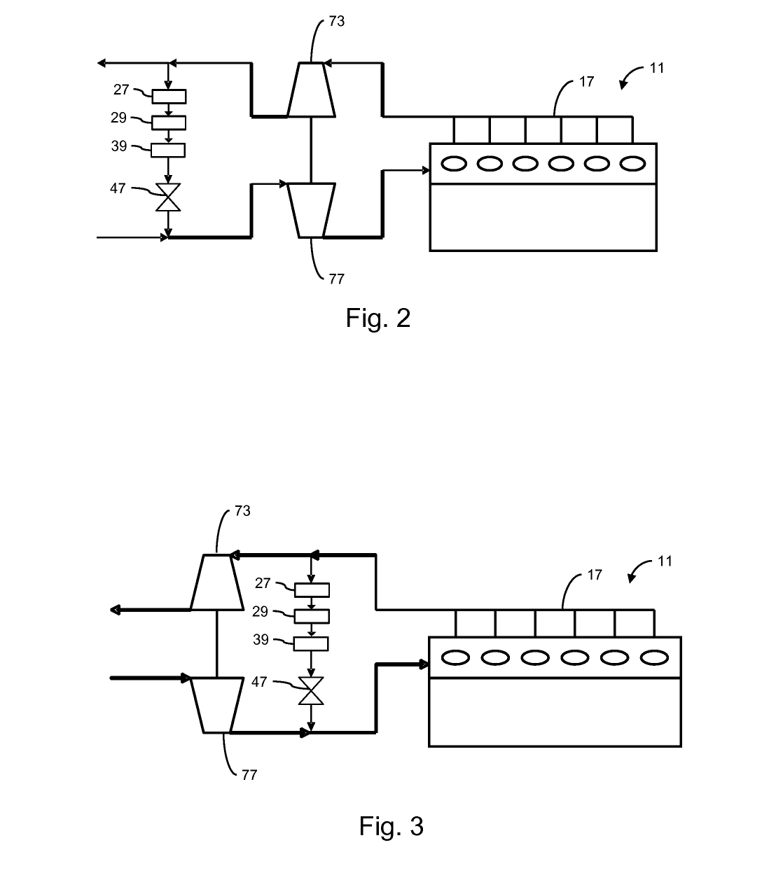

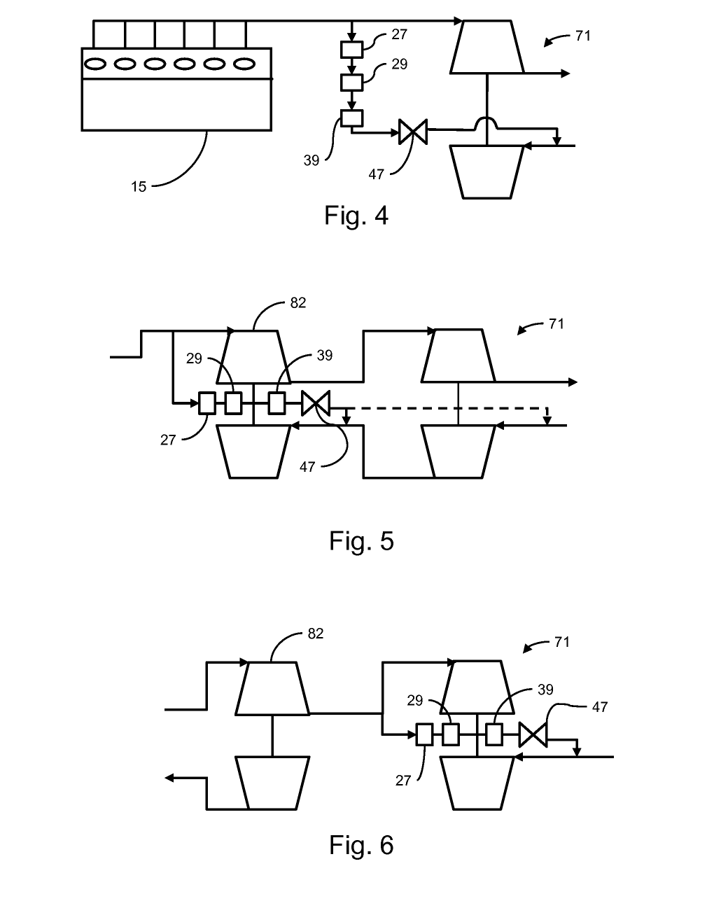

EGR system 9 may be implemented in a low pressure EGR system illustrated in FIG. 2, a high pressure EGR system illustrated in FIG. 3 or any combination such that EGR gas flows from higher pressure to lower pressure, with such examples shown in FIGS. 4, 5, and 6. In FIGS. 5 and 6 a power turbine 82 may be substituted for variable exhaust gas control valve 23. In a low pressure EGR system the passage for EGR is provided from downstream of the turbine 73 to the upstream side of the compressor 77. In a high pressure EGR system the EGR is passed from upstream of the turbine 73 to downstream of the compressor 77.

In alternate EGR systems, the passage for EGR is routed to flow EGR from a higher exhaust pressure location to a lower inlet pressure location.

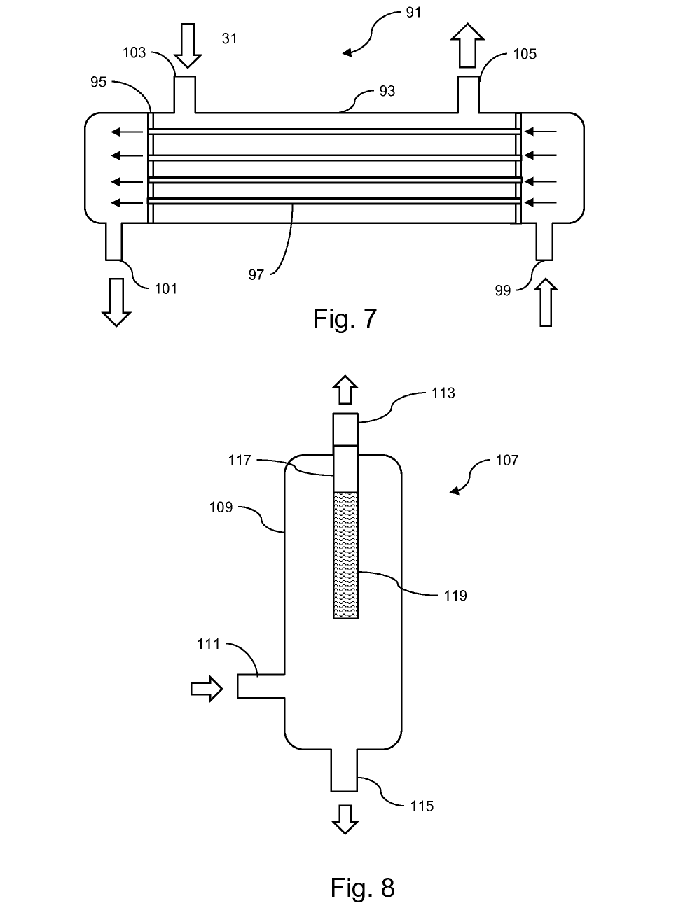

Illustrated in FIG. 7 is an embodiment of a cooler such as first stage cooler 27 and second stage cooler 29 in the form of a shell tube heat exchanger 91. The shell and tube heat exchanger 91 may include a housing 93 with a pair of tube sheets 95 internally disposed on opposite ends of the housing 93. The tube sheets 95 support a tube bundle 97. The housing 93 is provided with an exhaust gas input port 99 and an exhaust gas output port 101 and coolant input port 103 and coolant output port 105. A parallel flow coolant flow arrangement can also be used; where coolant enters coolant input port 105 and exits at the outlet port 105. Exhaust gas enters the exhaust gas input port 99 and passes through the tube bundle 97. Coolant (or heating fluid in the case of a reheater) enters coolant input port 103 and flows around the tube bundle 97 removing heat (or adding heat in the case of a reheater) from the exhaust gas passing through the tube bundle 97.

Illustrated in FIG. 8 is an embodiment of a mesh mist eliminator 107 that may be used as a mist eliminator 39 in the EGR system 9 illustrated in FIG. 1. The mist eliminator 107 includes a mist eliminator housing 109 having an exhaust gas input port 111 and exhaust gas output port 113. Mist eliminator housing 109 may also be provided with a condensate output port 115. The mist eliminator housing 109 supports a cylindrical core 117 on which is disposed a wire mesh 119. Saturated gas enters the exhaust gas input port 111 and a condensate is precipitated by wire mesh 119 and removed through condensate output port 115. Other types of mist eliminators 39 may be used, such as for example, a vane type, a centrifugal type, a sonic type, an electromagnetic type, a baffle type, and an electrostatic type.

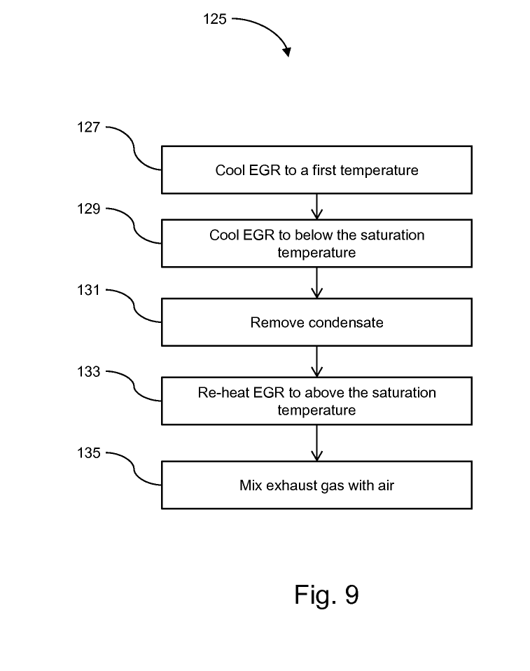

FIG. 9 is a process diagram illustrating a method of treating EGR gas 125 in accordance with an embodiment of the present invention. In step 127 the method may cool the EGR gas using the first stage cooler 27 to a first temperature. In one embodiment, the exhaust gas may be cooled to the temperature of the coolant of the engine jacket. In step 129 the method of treating EGR gas 125 may cool the exhaust gas to a temperature below the saturation temperature by, for example, using the second stage cooler 29. By cooling the EGR to a target temperature below the saturation temperature the percentage water vapor in the exhaust gas can be controlled. This may be accomplished using the second stage cooler 29 in combination with an auxiliary coolant source (not shown) such as a water source maintained at a lower temperature. In one embodiment the temperature of the auxiliary water source may be approximately 55° C. In step 131 the method of treating EGR gas 125 may remove condensate such as water droplets from the exhaust gas. In one embodiment this may be accomplished with the mist eliminator 39. The removal of the condensate also serves to remove other particulate contaminants that may damage components of the EGR system 9. After removal of the condensate, a saturated exhaust gas mixture remains. In step 133 the method of treating EGR gas 125 may reheat the exhaust gas to a temperature above the saturation temperature. In one embodiment, this may be accomplished with a reheater 4 where the heating fluid is jacket cooling fluid. Reheating of the saturated exhaust gas ensures that no liquid droplets pass into the compressor blades. In step 135 the method of treating EGR gas 125 may mix exhaust gas with air to provide an air and exhaust gas mixture to the engine 11.

The invention disclosed may be used with various types of reciprocating engine such as compression ignition and spark ignition engines that combust hydrocarbon fuels such as diesel fuel, natural gas fuel, gasoline and the like. Additionally the EGR system may be used with a turbine or other types of combustion engines that may benefit from an EGR system.

The flowcharts and step diagrams in the Figures illustrate the architecture, functionality, and operation of possible implementations of systems, and methods, according to various embodiments of the present invention. It should also be noted that, in some alternative implementations, the functions noted in the step may occur out of the order noted in the Figures. For example, two steps shown in succession may, in fact, be executed substantially concurrently, or the steps may sometimes be executed in the reverse order, depending upon the functionality involved. It will also be noted that each step of the step diagrams and/or flowchart illustration, and combinations of steps in the step diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. Where the definition of terms departs from the commonly used meaning of the term, applicant intends to utilize the definitions provided below, unless specifically indicated. As used herein, the singular forms “a”, “an” and “the” are intended to include the plural forms as well, unless the context clearly indicates otherwise. It will be further understood that the terms “comprises” and/ or “comprising,” when used in this specification, specify the presence of stated features, integers, steps, operations, elements, and/ or components, but do not preclude the presence or addition of one or more other features, integers, steps, operations, elements, components, and/ or groups thereof. It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any, and all, combinations of one or more of the associated listed items. As used herein. the phrases “coupled to” and “coupled with” as used in the specification and the claims contemplates direct or indirect coupling.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A system for recirculating exhaust gas, comprising:
a cooling subsystem configured to cool the exhaust gas;
a condensation removal subsystem; and
a temperature adjustment subsystem.

2. The system of claim 1, wherein the cooling subsystem is configured to cool the exhaust gas to below a saturation temperature.

3. The system of claim 1, wherein the temperature adjustment subsystem is configured to increase the temperature of the exhaust gas to above the saturation temperature.

4. The system of claim 1, wherein the cooling subsystem comprises a first cooling component configured to cool the exhaust gas to a first intermediate temperature and a second cooling component configured to cool the exhaust gas to a temperature below a saturation temperature.

5. The system of claim 1, wherein the cooling subsystem comprises a heat exchanger.

6. The system of claim 5, wherein the heat exchanger comprises a heat exchanger selected from among a group consisting of a shell and tube heat exchanger; a plate heat exchanger; a plate and shell heat exchanger; and a plate fin heat exchanger.

7. The system of claim 1, wherein the condensation removal subsystem comprises a mist eliminator configured to remove condensate from the exhaust gas.

8. The system of claim 1 wherein the condensation removal subsystem comprises a mist eliminator configured to function as an absorber.

9. The system of claim 1 herein the condensation removal subsystem comprises a mist eliminator configured to function as a scrubber.

10. The system of claim 7, wherein the condensation removal subsystem further comprises a conduit for removing the condensate from the mist eliminator.

11. The system of claim 10 wherein the condensate comprises a mixture of water, dissolved organic compounds and solid particles.

12. The system of claim 7, wherein the mist eliminator comprises a mist eliminator selected from among a group consisting of a mesh type, a vane type, a centrifugal type, a sonic type, an electromagnetic type, a baffle type, and an electrostatic type.

13. The system of claim 12 further comprising a valve disposed on the conduit.

14. The system of claim 13, further comprising a control subsystem for controlling the valve.

15. An engine, comprising:
a combustion chamber wherein fuel is combusted producing an exhaust gas at a first temperature;
an exhaust system coupled with the combustion chamber that collects the exhaust gas;
an exhaust gas cooling system configured to reduce exhaust gas temperature to below a saturation temperature;
a condensate removal system coupled with the exhaust gas cooling system configured to precipitate a condensate from the exhaust gas; and
an intake system coupled with the condensate removal system and the combustion chamber.

16. The engine of claim 15, wherein the exhaust gas cooling system comprises:
a first cooler configured to cool the exhaust gas to a first temperature; and
a second cooler configured to cool the exhaust gas to below the saturation temperature.

17. The engine of claim 15, wherein the condensate removal system comprises a mist eliminator.

18. The engine of claim 17, further comprising a conduit coupled with the mist eliminator configured to remove water and particulate matter.

19. The engine of claim 15, further comprising an exhaust gas reheating system configured to reheat the exhaust gas to a temperature above the saturation temperature.

20. A method of recirculating exhaust gas, comprising:
cooling the exhaust gas to a temperature below a saturation temperature;
removing condensate from the exhaust gas; and
heating the exhaust gas to a temperature above the saturation temperature.

21. The method of claim 20, wherein cooling the exhaust gas to a temperature below a saturation temperature comprises:
cooling the exhaust gas to a first intermediate temperature; and
cooling the exhaust gas to a temperature below a steam saturation temperature.

22. The method of claim 20, wherein removing condensate from the exhaust gas comprises passing the exhaust gas though a mist eliminator to remove condensate and particulates

23. The method of claim 20, wherein heating the exhaust gas to a temperature above the saturation temperature comprises passing the exhaust gas through a heat exchanger configured to reheat the exhaust gas to above the steam saturation temperature.

24. The method of claim 20, further comprising controlling a mass flow rate of the exhaust gas.

25. The method of claim 20, wherein removing condensate from the exhaust comprises removing condensate droplets and solids attached to the condensate droplets.

26. The method of claim 20, wherein removing condensate from the exhaust comprises removing condensate droplets and liquids attached to the condensate droplets.

27. The method of claim 20, wherein removing condensate from the exhaust comprises removing condensate droplets and liquids dissolved in the condensate droplets.

28. The method of claim 20, wherein removing condensate from the exhaust comprises removing condensate droplets and gaseous components absorbed into the droplets.
